(19) United States
(12) Patent Application Publication
(10) Pub. No.: US 2006/0244877 A1
(43) Pub. Date: Nov. 2, 2006

(54) Liquid crystal display apparatus having a light guiding plate

(76) Inventors: Jae-heon Noh, Yongin-si (KR); Su-dong Moon, Suwon-si (KR); Young-min Seo, Seongnam-si (KR); In-youl Seo, Suwon-si (KR); Dong-seob Jang, Seoul (KR); Yong-joon Choi, Suwon-si (KR); Seong-ho Youn, Hwaseong-si (KR)

Correspondence Address: STANZIONE & KIM, LLP, 919 18TH STREET, N.W., SUITE 440, WASHINGTON, DC, 20006, US

(21) Appl. No.: 11/283,924

(22) Filed: Nov. 22, 2005

(30) Foreign Application Priority Data
Apr. 27, 2005 (KR) 2005-35047

(51) Int. Cl. G02F 1/1335

(52) U.S. Cl. 349/64

(57) ABSTRACT

An LCD includes an LCD panel, a light guiding plate including a light guiding plate main body disposed behind the LCD panel and a reflective polarizing layer formed on a surface of the light guiding plate main body to face the LCD panel, and a light source disposed on at least one side of the light guiding plate. The LCD has a high light efficiency by using a light guiding plate since a reflective polarizing layer is formed on the light guiding plate.

### CROSS-REFERENCE TO RELATED APPLICATIONS

This application claims the benefit under 35 U.S.C. §119 from Korean Patent Application No. 2005-35047, filed on Apr. 27, 2005, in the Korean Intellectual Property Office, the disclosure of which is incorporated herein in its entirety by reference.

### BACKGROUND OF THE INVENTION

1. Field of the Invention

The present general inventive concept relates to a liquid crystal display apparatus, and more particularly, to a liquid crystal display apparatus including a light guiding plate having a function of reflective polarization and improving light efficiency.

2. Description of the Related Art

Recently, a flat panel display apparatus, such as a liquid crystal display (LCD), a plasma display panel (PDP), or an organic light emitting diode (OLED), has been developed to replace a cathode ray tube (CRT).

The LCD comprises an LCD panel having a Thin Film Transistor (TFT) substrate, a color filter substrate and a liquid crystal layer interposed between the two substrates. Since the LCD panel does not emit light by itself, the LCD may comprise a backlight unit disposed behind the TFT substrate. The transmittance of the light from the backlight unit is adjusted according to an alignment of the liquid crystal layer. The LCD panel and the backlight unit are held in a chassis.

The backlight unit may be classified into one of an edge type backlight unit and a direct type backlight unit according to a location of a light source. In the edge type backlight unit, a light source like a cold cathode fluorescent lamp (CCFL) is disposed on a side of a light guiding plate, and an optical film is disposed between the light guiding plate and the LCD panel.

Meanwhile, a polarizing plate adheres to an external surface of the LCD panel. Since the polarizing plate passes only a P wave component of a non-polarized light, but not an S wave component of the non-polarized light, a predetermined portion of the light generated from the light source may not be incident to the LCD panel but is absorbed or reflected.

In order to decrease the light absorption, a conventional reflective polarizing film has been used to transmit the P wave and to recycle the S wave. The conventional reflective polarizing film is made of hundreds of acryl films each having a given polarization. However, the conventional reflective polarizing film is manufactured by an adhering method using an acryl film, therefore, a manufacturing cost is high and a foreign substance may be generated when cutting the acryl film.

### SUMMARY OF THE INVENTION

The present general inventive concept provides a liquid crystal display apparatus having a high light efficiency by using a light guiding plate on which a reflective polarizing layer is formed.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an LCD comprising an LCD panel, a light guiding plate comprising a light guiding plate main body disposed on a side of the LCD panel and a reflective polarizing layer formed on a surface of the light guiding plate main body facing the LCD panel, and a light source disposed on at least one side of the light guiding plate such that the light emitted from the light source is transmitted toward the LCD panel through the light guiding plate.

The reflective polarizing layer may comprise a first sub-layer having a first refractivity and a second sub-layer having a second refractivity.

A difference between the first refractivity of the first sub-layer and the second refractivity of the second sub-layer may be 0.5 or more.

The first sub-layer and the second sub-layer may be alternately disposed one or more times.

The first sub-layer and the second sub-layer may be respectively alternately disposed 2˜10 times.

One of the first sub-layer and the second sub-layer is made of SiO₂ or MgF₂ and the other one of the first sub-layer and the second sub-layer is made of TiO₂.

A thickness of the first sub-layer and a thickness of the second sub-layer may be between 10 nm˜1000 nm.

The reflective polarizing layer may be formed by a coating method.

The coating method may be a CVD method, a PECVD method, a sputtering method or PVD method.

The LCD may further comprise light scatterers scattered inside the light guiding plate main body and having different refractivity from the light guiding plate main body.

The light guiding plate main body may be made of an acryl resin and the light scatterers may be made of polystyrene.

The light scatterers may have a spherical shape.

A prism pattern or a V-cut pattern may be formed on a second surface thereof opposite to the surface facing the LCD panel.

The light source may be disposed on one side or opposite sides of the light guiding plate, and an extended direction of the prism pattern or the V-cut pattern may be perpendicular to an extended direction of the light source.

The light guiding plate main body may comprise an incident angle increasing part slanting with respect to the light source and formed on the light guiding plate main body.

The incident angle increasing part may extend along the extended direction of the light source.

The incident angle increasing part may include a plurality of sub-parts formed parallel to each other.

The light source may comprise a first light source and a second light source which are respectively disposed opposite sides of the light guiding plate and the light guiding plate main body may comprise a first incident angle increasing part slanting with respect to the first light source and a second incident angle increasing part slanting with respect to the second light source, respectively.

The first incident angle increasing part and the second incident angle increasing part may be formed on adjacent to the first light source and the second light source, respectively.

The light source may comprise a lamp.

The light source may comprise an LED.

The LCD may further comprise a prism sheet disposed between the LCD panel and the light guiding plate.

The foregoing and other aspects of the present general inventive concept may also be achieved by providing a backlight unit usable with an LCD panel and a light source, the backlight unit comprising a light guiding plate having a first side to receive light, and a second side formed with a saw-tooth shape to emit light towards the LCD panel, and a reflecting plate disposed on a third side of the light guiding plate opposite to the second side to receive light from the light guiding plate through the third side and to reflect received light towards the LCD panel through the third and the second side.

The foregoing and other aspects of the present general inventive concept may also be achieved by providing an LCD comprising an LCD panel, a light source, and a light guiding plate having a first side to receive light from the light source and a second side formed with a saw-tooth shape to transmit the received light toward the LCD panel, and a reflecting plate disposed on a third side of the light guiding plate opposite to the second side to receive the light from the light guiding plate through the third side and to reflect the received light toward the LCD panel through the third side and the second side.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of an LCD according to an embodiment of the present general inventive concept.

FIG. 2 is a cross-sectional view of the LCD of FIG. 1.

FIG. 3 is a view of taken along a line III-III of FIG. 1.

FIG. 4 illustrates paths of light in the light guiding plate of FIG. 1.

FIG. 5 is a graph representing a transmittance of polarized components of light as a function of a light wavelength for the LCD the embodiment illustrated in FIGS. 1-4.

FIG. 6 is a graph representing a reflectance of polarized components of the light as a function of a light wavelength for the LCD according to the embodiment illustrated in FIGS. 1-4.

FIG. 7 is a sectional view of a main part of an LCD according to another embodiment of the present general inventive concept.

FIG. 8 is a perspective view of a main part of an LCD according to another embodiment of the present general inventive concept.

FIG. 9 is a perspective view of a main part of an LCD according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout the description. The embodiments are described below in order to explain the present general inventive concept while referring to the figures.

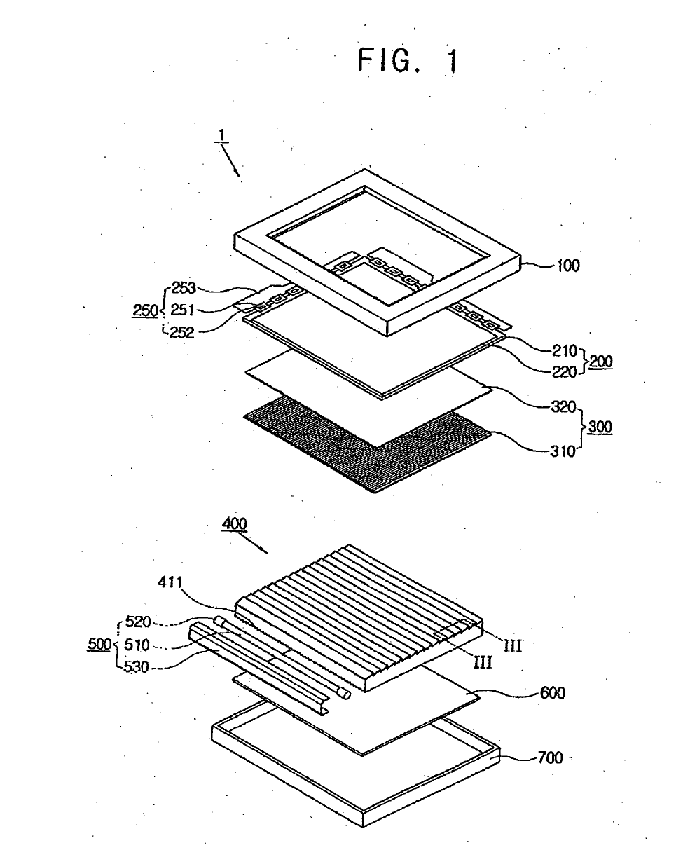

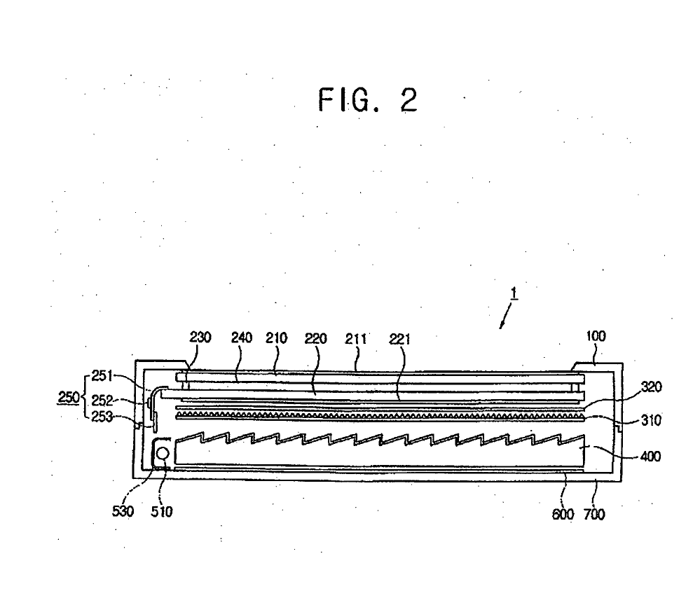

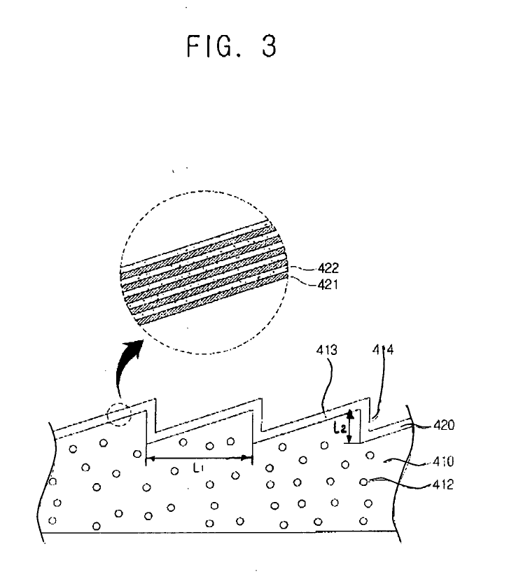

FIG. 1 is an exploded perspective view of an LCD 1 according to an embodiment of the present general inventive concept, FIG. 2 is a cross-sectional view of the LCD 1 of FIG. 1, and FIG. 3 is a view taken along line III-III of FIG. 1.

Referring to FIGS. 1-3, the LCD 1 comprises an LCD panel 200, an optical film 300 disposed under the LCD panel 200 and a light guiding plate 400 disposed under the optical film 300 to direct light emitted from a light source 500 toward the optical film 300. The light source 500 is disposed along one side of the light guiding plate 400, and a reflecting plate 600 is disposed under the light guiding plate 400. The LCD panel 200, the optical film 300, the light guiding plate 400, the light source 500 and the reflecting plate 600 are disposed between a top chassis 100 and a bottom chassis 700.

The LCD panel 200 comprises a TFT substrate 210 on which thin film transistors (TFTs) are formed, a color filter substrate 220 facing the TFT substrate 210, a sealant 230 to adhere the two substrates 210 and 220 and to form a cell gap, and a liquid crystal layer 240 encompassed by the two substrates 210 and 220 and the sealant 230. Polarization filters 211 and 221 are respectively attached to external surfaces of the TFT substrate 210 and the color filter substrate 220. The LCD panel 200 controls alignment of the liquid crystal layer 240, thereby forming an image thereon. However, the LCD panel 200 is provided with the light emitted from the light source 500 disposed behind the LCD panel 200, since the LCD panel 200 does not emit the light by itself.

On a side of the TFT substrate 210 is disposed a driving part 250 to apply driving signals. The driving part 250 comprises a flexible printed circuit (FPC) 251, a driving chip 252 seated on the flexible printed circuit 251 and a printed circuit board (PCB) 253 connected to a side of the flexible printed circuit 251. Here, the driving part 250 is formed in a chip on film (COF) type as shown in FIG. 1. However, the driving part 250 may be formed of any well-known types, such as, tape carrier package (TCP), chip on glass (COG), etc. Moreover, the driving part 250 may be formed on the TFT substrate 210 while wirings are formed therebetween.

The optical film 300 disposed under the LCD panel 200 may comprise a prism film 310 and a protection film 320.

Triangular micro prism shapes may be formed on the prism film 310 at a predetermined alignment. The prism film 310 concentrates incident light in a direction perpendicular to a surface of the LCD panel 200. Two layers of prism films can be used as the prism film 310, and the triangular micro prism shapes can be formed on each prism film layer to form a predetermined angle with each other. The light passing through the prism film 310 is transmitted vertically, thereby forming a uniform brightness distribution.

The protection film 320 may be disposed on a top of the optical film 300 to protect the prism film 310 that is vulnerable to a scratch and can be damaged by an external article.

The optical film 300 is not limited to this embodiment, but may be modified variously to perform the intended purpose of the general inventive concept. For example, to perform the intended function, the prism film 310 may be replaced or modified by adjusting shapes of an incident angle increasing part 413 and a perpendicularly connecting part 414 of the light guiding plate 400.

The light guiding plate 400 is disposed under the optical film 300. The light guiding plate 400 converts light from the light source 500 disposed on the one side thereof into a plane surface light and provides the plane surface light to the LCD panel 200. The light guiding plate 400 comprises an incident surface formed on the side to face the light source 500 and an exiting surface to face the LCD panel 200. Light incident to the incident surface exits through an overall surface of the exiting surface.

The light guiding plate 400 comprises a light guiding plate main body 410 and a reflective polarizing layer 420. The reflective polarizing layer 420 is formed on the exiting surface of the light guiding plate 400, that is, a surface of the light guiding plate main body 410 facing the LCD panel 200.

The light guiding plate 400 is formed in a substantially rectangular shape and is made of polymethyl methacrylate (PMMA), which is an acryl resin. On an underside of the light guiding plate main body 410 is formed a prism pattern 411. An extended direction of the prism pattern 411 is perpendicular to an extended direction of the light source 500. The extended direction of the light source 500 is a direction in which the light source 500 is disposed along the side of the light guide plate 400. The extended direction of the prism pattern 411 is a direction in which grooves of the prism pattern 411 are formed. The light guiding plate main body 410 may contain light scatterers 412 which are scattered therein. The light scatterers may have a spherical shape. The light scatterer 412 scatters and reflects the incident light and may be made of polystyrene, etc., having a different refractivity from the light guiding plate main body 410. On the light guiding plate main body 410 is formed the perpendicularly connecting part 414 disposed between a plurality of adjacent incident angle increasing parts 413. The incident angle increasing part 413 and the perpendicularly connecting part 414 may form a saw-tooth shape. The incident angle increasing part 413 slants with respect to the light source 500 and is formed to increase a propagation angle of light after passing through the incident angle increasing part 413.

As illustrated in FIG. 1, the incident angle increasing parts 413 are disposed parallel to the extended direction of the light source 500. The incident angle increasing part 413 has a width L1 in a direction perpendicular to the extended direction of the light source. Further, since each incident angle increasing part 413 has same slope, each perpendicularly connecting part 414 has same height L2 in the extended direction of the prism pattern 411.

The reflective polarizing layer 420 is formed on the incident angle increasing part 413 and the perpendicularly connecting part 414. The reflective polarizing layer 420 comprises a first sub-layer 421 and a second sub-layer 422, which have a different refractivity and are disposed alternately. In the present embodiment, the first sub-layer 421 and the second sub-layer 422 are piled in 5 layers, respectively, the first sub-layer 421 is made of SiO₂, and the second sub-layer 422 is made of TiO₂. The first sub-layer 421 may be made of MgF₂.

The refractivity of the first sub-layer 421 and the second sub-layer 422 are respectively about 0.46 and about 1.4, which are different from the refractivity of the light guiding plate main body 410, which refractivity is 0.49, when the light guiding plate main body 410 is made of PMMA. A difference between the refractivity of the first sub-layer 421 and the refractivity of the second sub-layer 422 is approximately 0.94. Here, the refractivity is an index of refraction minus one.

The reflective polarizing layer 420 is formed by a coating method such as chemical vapor deposition (CVD), plasma enhanced chemical vapor deposition (PECVD), sputtering, physical vapor deposition (PVD), etc. The reflective polarizing layer 420 may be formed without performing an adhering process, and may comprise a plurality of layers. Further, a foreign substance is not generated since the coating method does not have a cutting process. Thicknesses of the first sub-layer 421 and the second sub-layer 422 may be between 10˜1000 nm. When the sub-layers are 10 nm or less, the corresponding reflective polarizing effect is low and it is not easy to form a thinner layer than 10 nm. When the sub-layers are 1000 nm or more, a forming time is very long and the reflective polarizing effect is not increased while light transmittance decreases. If the coating method is used, it may be easier to respectively control the thicknesses of the two sub-layers 421 and 422 in a range 10 nm through 1000 nm. The first sub-layer 421 and the second sub-layer 422 are respectively piled 2˜10 times.

The light source 500 is disposed along the one side of the light guiding plate 400 and comprises a lamp 510, a lamp holder 520 to support an end of the lamp 510 and a lamp reflector 530 to encompass the lamp.

The lamp 510 is a fluorescent lamp, which may be a Cold Cathode Fluorescent Lamp (CCFL) or an External Electrode Fluorescent Lamp (EEFL). The fluorescent lamp uses a plasma principle, and in the lamp is a sealed discharging gas such as mercury (Hg), neon (Ne), argon (Ar), etc. When a high voltage is applied to an electrode of the lamp 510, an electron is emitted from the electrode by an electric field. The emitted electron excites the gas, for example, mercury, thereby generating ultraviolet light. The ultraviolet light generated is converted into a visible light to be emitted outside the lamp 510, by a fluorescent layer.

The lamp holder 520 includes an electrode of the lamp 510, not shown, and protects a connection between the lamp 510 and an inverter, not shown. The lamp holder 520 may be made of a resin such as silicone.

The lamp reflector 530 reflects the light emitted from the lamp 510 to the light guiding plate 400. The lamp reflector 530 may be made of aluminum having a good reflectance or other materials suitable to perform the intended purpose, and a surface of the lamp reflector 530 facing the lamp 510 may be coated with silver.

The reflecting plate 600 disposed under the light guiding plate 400 reflects the light transmitted or reflected from the light guiding plate 400 back to the light guiding plate 400. The reflecting plate 600 may be made of polyethylene terephthalate (PET), polycarbonate (PC), or other materials suitable to perform the intended purpose.

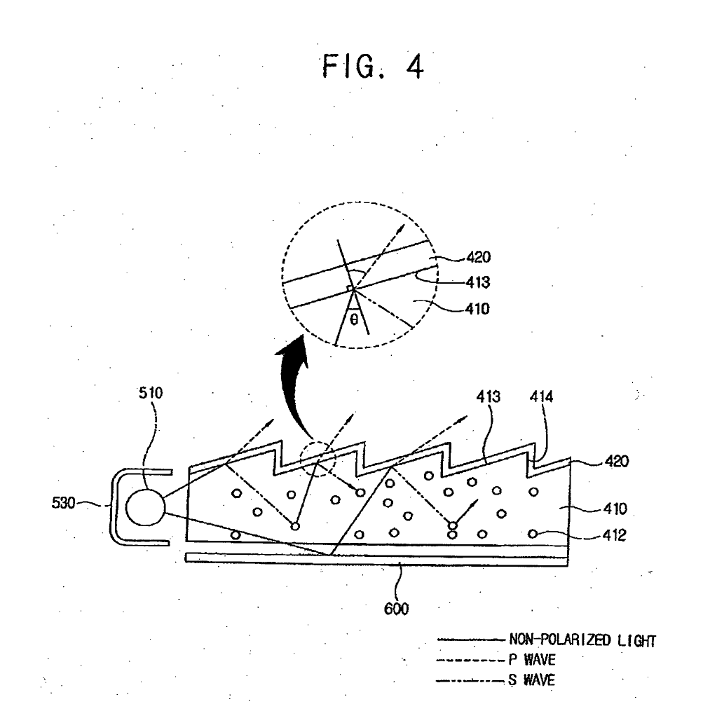

Hereinafter, paths of light in the LCD 1 according to the embodiment of the general inventive concept will be described with reference to FIG. 4.

A portion of the light generated from the lamp 510 passes through the light guiding plate main body 410 and is incident to the reflective polarizing layer 420. Another portion of the light is reflected on the reflecting plate 600, passes through the light guiding plate main body 410, and then is incident to the reflective polarizing layer 420. The light incident to the reflecting plate 600 has an increased incident angle due to the prism pattern 411 formed on the underside of the light guiding plate main body 410. The light incident to the reflective polarizing layer 420 is partly transmitted and partly reflected according to the refractivity difference between the light guiding plate main body 410 and the reflecting polarizing layer 420, that is, a P polarized light wave is transmitted while an S polarized light wave is reflected. Since the first sub-layer 421 and the second sub-layer 422 are alternatively formed on the reflective polarizing layer 420, and have different refractivities, transmittance of the P wave and reflection of the S wave include a cumulative effect of an interface between the two sub-layers 421 and 422. Through the abovementioned process, most of the P wave is provided to the LCD panel 200 and most of the S wave is reflected back to the light guiding plate main body 410. In order to improve an efficiency of polarization-separation of the transmittance of the P wave and the reflection of the S wave generated on the interface between the two sub-layers 421,422, the difference of refractivity between the two sub-layers 421 and 422 may be 0.5 or more. The S wave, which is reflected back into the light guiding plate main body 410 may be reflected by the light scatterer 412 and is non-polarized. Non-polarized light may directly be incident to the reflective polarizing layer 420 or may be incident to the reflective polarizing layer 420 after being reflected by the reflecting plate 600. The non-polarized light incident to the reflective polarizing layer 420 becomes polarized when being incident to the reflective polarizing layer 420. Thus, the reflective polarizing layer 420 transmits the P wave and recycles the S wave, thereby improving a light usage efficiency to efficiently provide the P wave the LCD panel 200. Accordingly, much of light from the light source 500 is polarized as the P wave and passes through the polarizer 211 attached to the TFT substrate 210, therefore, the light usage efficiency of the LCD 1 is improved.

Meanwhile, most of the light incident to the reflective polarizing layer 420 may be incident through the incident angle increasing part 413. Since the incident angle increasing part 413 slants with respect to the lamp 510, an incident angle E of the incident light becomes relatively large and the efficiency of polarization-separation thereof is increased. The slope of the incident angle increasing part 413 is controlled so that total-reflected light is not excessive. When the light guiding plate main body 410 is made of PMMA, a critical angle is about 42 degrees.

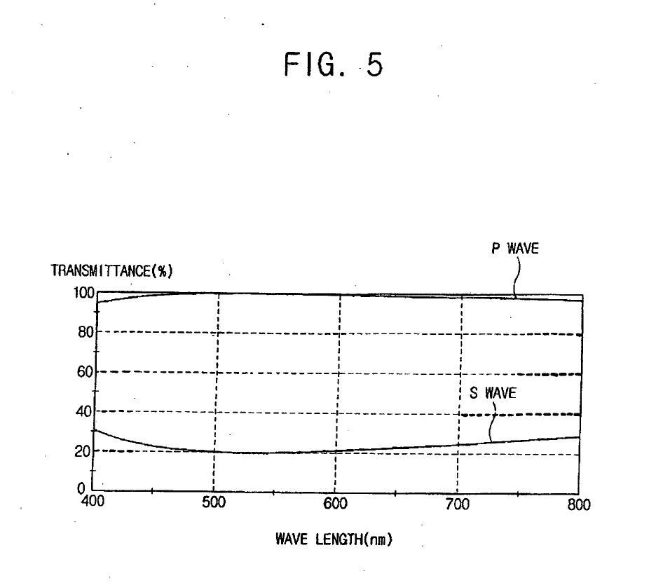

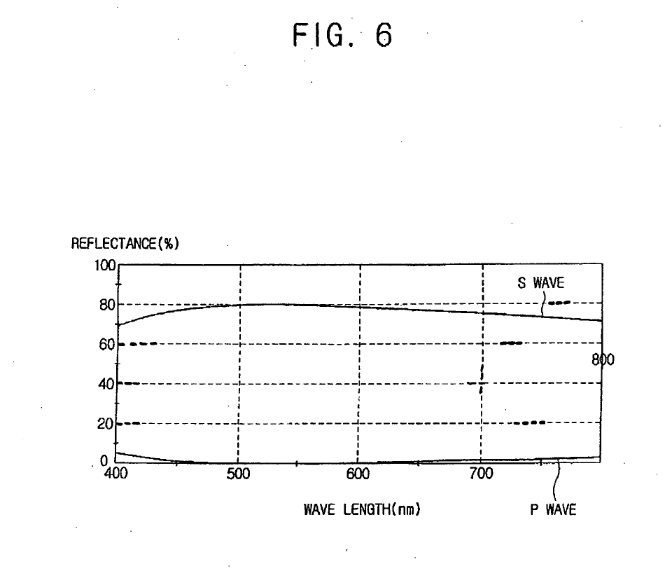

Hereinbelow, an effect of polarization-separation according to the present embodiment will be described with reference to the graphs in FIGS. 5 and 6.

FIG. 5 is a graph representing a transmittance of polarized components of light as a function of a wavelength of the light for the LCD 1 of FIG. 1 and FIG. 6 is a graph representing a reflectance of polarized components of light as a function of the wavelength of the light for the LCD 1 of FIG. 1.

The two graphs represent the transmittance and the reflectance of light passing through the light guiding plate 400, respectively.

As illustrated in FIG. 5, the transmittance of the P wave is 90% or more, which is close to 100% in a range of 400˜700 nm, that is, a wavelength of visual light. However, transmittance of the S wave is 30% or less, which is close to 20%. FIG. 6 illustrates a low reflectance of the P wave and a high reflectance of the S wave.

Therefore, in the LCD 1, the light usage efficiency may be improved without using an additional reflective polarizing film.

The abovementioned embodiment may be variously modified. The reflective polarizing layer 420 may be formed in a single layer or may be formed in 3 or more sub-layers. When formed in the single layer, the reflective polarizing layer 420 may be made of TiO₂, which has a high difference of refractivity from the light guiding plate main body 410. The width and the slope of the incident angle increasing part 413 may not be same other incident angle increasing parts but may be varied depending on a location thereof.

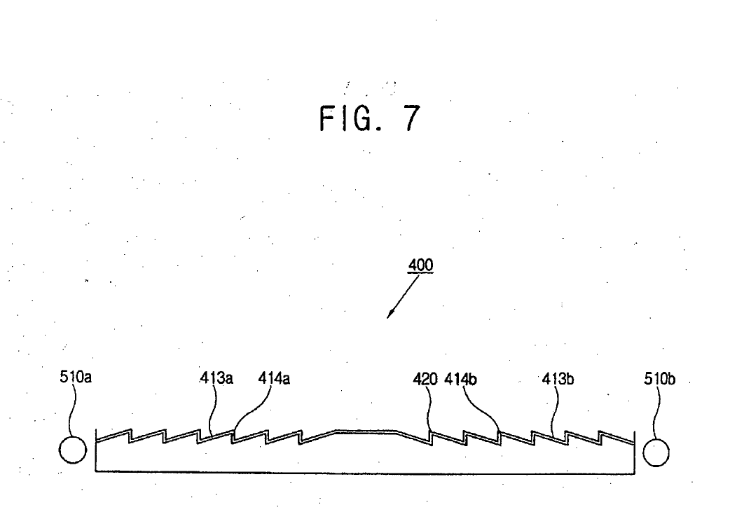

Next, an LCD according to embodiments of the present general inventive concept will be described with reference to FIGS. 7 through 9.

FIG. 7 is a cross-sectional view of a main part of the LCD according to another embodiments and shows a light guiding plate 400 and first and second lamps 510a and 510b. The first and second lamps 510a and 510b are respectively disposed on opposite sides of the light guiding plate 400. Incident angle increasing parts 413a and 413b are respectively formed on an exiting surface of a light guiding plate main body 410. The incident angle increasing parts 413a and 413b are inclined towards the opposite lamps. For example, the incident angle increasing parts 413a comprises a first incident angle slanting with respect to the first lamp 510a and a second incident angle increasing part 413b slanting with respect to the second lamp 510b. A first perpendicularly connecting part 414a is disposed between the adjacent first incident angle increasing parts 413a and a second perpendicularly connecting part 414b is disposed between the adjacent second incident angle increasing parts 413b.

As a size of the LCD becomes large, two light sources 500 may be provided on both opposite sides of the light guiding plate 400 in order to improve brightness. In this case, effect of polarization-separation may be improved according to the embodiment described above. The light emitted by the first lamp 510a is mainly polarized and separated in the adjacent first incident angle increasing parts 413a and the light emitted by the second lamp 510b is mainly polarized and separated in the adjacent second incident angle increasing parts 413b. The first incident angle increasing part 413a increases an incident angle of the light emitted by the first lamp 510a, and the second incident angle increasing part 413b increases an incident angle of light emitted by the second lamp 510b, thereby improving efficiency of the polarization-separation.

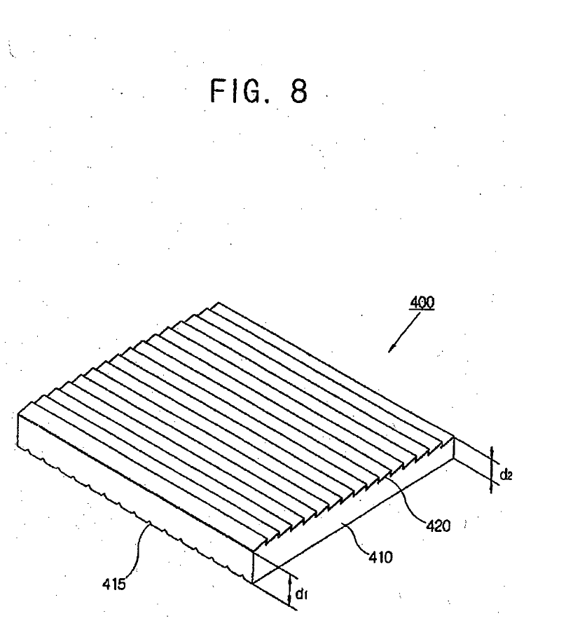

FIG. 8 is a perspective view of a main part of the LCD according to another embodiment of the present general inventive concept and shows a light guiding plate 400. The light guiding plate 400 is a wedge type and a thickness d1 of the side of the light guiding plate 400 where a light source 500 is disposed is thicker than a thickness d2 of an opposite side of the light guiding plate 400. A V-cut pattern 415 is formed on an underside of the light guiding plate 400. The V-cut pattern 415 is formed in a press method, etc., and functions similarly to the prism pattern 411 in the previous embodiment. A projecting pattern, a reflecting pattern or the like may be formed on the underside of the light guiding plate 400.

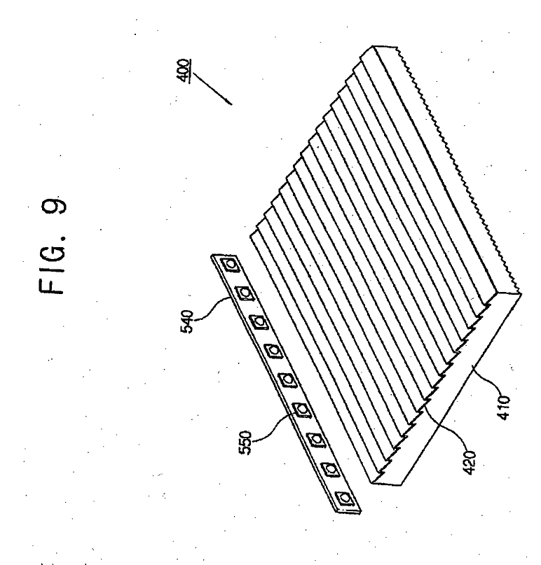

FIG. 9 is a perspective view of a main part of the LCD according to another embodiment of the present general inventive concept and shows a light guiding plate 400 and a light source 500. The light source comprises an LED circuit board 540 and an LED 550 seated on the LED circuit board 540. The LED 550 has an excellent brightness and an excellent color reproducibility. The LED 550 may comprise LEDs 550 respectively emitting red, green and blue.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An LCD comprising:
an LCD panel;
a light guiding plate comprising a light guiding plate main body disposed on a side of the LCD panel and a reflective polarizing layer formed on a surface of the light guiding plate main body facing the LCD panel; and
a light source disposed on at least one side of the light guiding plate such that the light emitted from the light source is transmitted toward the LCD panel through the light guiding plate.

2. The LCD according to claim 1, wherein the reflective polarizing layer comprises a first sub-layer having a first refractivity and a second sub-layer having a second refractivity.

3. The LCD according to claim 2, wherein a difference between the first refractivity of the first sub-layer and the second refractivity of the second sub-layer is 0.5 or more.

4. The LCD according to claim 2, wherein the first sub-layer and the second sub-layer are alternately disposed one or more times.

5. The LCD according to claim 4, wherein the first sub-layer and the second sub-layer are respectively alternately disposed 2˜10 times.

6. The LCD according to claim 2, wherein one of the first sub-layer and the second sub-layer is made of SiO₂ or MgF₂ and the other one of the first sub-layer and the second sub-layer is made of TiO₂.

7. The LCD according to claim 2, wherein a thickness of the first sub-layer and a thickness of the second sub-layer are between 10 nm˜1000 nm.

8. The LCD according to claim 1, wherein the reflective polarizing layer is formed by a coating method.

9. The LCD according to claim 8, wherein the coating method is one of a CVD, a PECVD, a sputtering method or PVD.

10. The LCD according to claim 1, further comprising:
light scatterers scattered inside the light guiding plate main body and having a different refractivity from the light guiding plate main body.

11. The LCD according to claim 10, wherein the light guiding plate main body is made of an acryl resin and the light scatterers are made of polystyrene.

12. The LCD according to claim 10, wherein the light scatterers have a spherical shape.

13. The LCD according to claim 1, wherein the light guiding plate comprises one of a prism pattern and a V-cut pattern formed on a second surface thereof opposite to the surface of the light guiding plate main body facing the LCD panel.

14. The LCD according to claim 13, wherein the at least one side of the light guiding plate comprises opposite sides, the light source is disposed on the opposite sides of the light guiding plate, and an extended direction of the one of the prism pattern and the V-cut pattern is perpendicular to an extended direction of the light source.

15. The LCD according to claim 1, wherein the light guiding plate main body comprises an incident angle increasing part slanting with respect to the light source and formed on the light guiding plate main body.

16. The LCD according to claim 15, wherein the incident angle increasing part is extended along an extended direction of the light source.

17. The LCD according to claim 16, wherein the incident angle increasing part comprises a plurality of sub-parts formed parallel to each other.

18. The LCD according to claim 1, wherein the at least one side of the light guiding plate comprises opposite sides, the light source comprises a first light source and a second light source which are respectively disposed on the opposite sides of the light guiding plate, and the light guiding plate main body comprises a first incident angle increasing part slanting with respect to the first light source and a second incident angle increasing part slanting with respect to the second light source.

19. The LCD according to claim 18, wherein the first incident angle increasing part and the second incident angle increasing part are formed adjacent to the first light source and the second light source, respectively.

20. The LCD according to claim 1, wherein the light source comprises a lamp.

21. The LCD according to claim 1, wherein the light source comprises an LED.

22. The LCD according to claim 1, further comprising:
a prism sheet disposed between the LCD panel and the light guiding plate.

23. A backlight unit usable with an LCD having an LCD panel and a light source, the backlight unit comprising:
a light guiding plate having a first side to receive light and a second side formed with a saw-tooth shape to emit the light towards the LCD panel; and
a reflecting plate disposed on a third side of the light guiding plate opposite to the second side to receive the light from the light guiding plate through the third side and to reflect the received light towards the LCD panel through the third side and the second side.

24. The backlight unit according to claim 23, further comprising:
a reflecting polarizing layer formed on the saw-tooth shape of the second side of the light guiding plate to transmit a first polarized light of the light towards the LCD panel and to reflect an second polarized light of the light towards the light guiding plate.

25. The backlight unit according to claim 24, wherein the third side comprises one of a prism pattern, a groove, and a protrusion formed thereon to face the reflecting plate.

26. The backlight unit according to claim 23, wherein the second side comprises an incident angle increasing part and a perpendicular connecting part to form the saw-tooth shape.

27. The backlight unit according to claim 26, wherein the light is incident to the light guiding plate through the first side in a direction, and the incident angle increasing part forms an angle less than 90° with the direction.

28. The backlight unit according to claim 23, wherein the light guiding plate comprises:
a light guiding plate main body formed by the first, the second and the third sides; and
scatterers contained in the light guiding plate main body to reflect the light reflected from the second side.

29. The backlight unit according to claim 23, wherein the light guiding plate comprises a fourth side opposite to the first side, and the light source comprises two light sources disposed along the first and the fourth sides of the light guiding plate, respectively.

30. An LCD comprising:
an LCD panel;
a light source to emit light;
a light guiding plate having a first side to receive light from the light source, and a second side formed with a saw-tooth shape to transmit the received light toward the LCD panel; and
a reflecting plate disposed on a third side of the light guiding plate opposite to the second side to receive the light from the light guiding plate through the third side and to reflect the received light toward the LCD panel through the third side and the second side.
